(19) United States
(12) Patent Application Publication
(10) Pub. No.: US 2014/0010614 A1
(43) Pub. Date: Jan. 9, 2014

(54) TENSIONER

(71) Applicant: MITEK HOLDINGS, INC., (US)

(72) Inventor: Robert Tan, Dandenong South (AU)

(73) Assignee: MITEK HOLDINGS, INC., Wilmington, DE (US)

(21) Appl. No.: 13/715,286

(22) Filed: Dec. 14, 2012

(30) Foreign Application Priority Data
Dec. 15, 2011 (AU) 2011254074

(51) Int. Cl. F16B 39/282

(52) U.S. Cl. CPC F16B 39/282
USPC 411/145

(57) ABSTRACT

A tensioner for a strap brace comprising: a cap for receiving a fastener and a strap brace, wherein the fastener secures the strap brace to the cap; the fastener comprising first and second members with interengageable threads, wherein either can be turned to bring the strap brace under tension; and a frictioned surface to prevent rotation of the other member when one member is turned.

### FIELD OF INVENTION

The present invention relates to devices suitable for tensioning strap braces.

### BACKGROUND

Strap braces are used on buildings to resist lateral loads caused by wind. Generally, strap braces are secured across a frame in a cross-wise fashion to tension the frame. This imparts a compressive force on the frame to transfer wind load on the frame to other parts of the building.

A problem with strap braces is that insufficient tension may be imparted to the frame when the brace is manually pulled and secured across the frame. To alleviate this problem, tensioners are used to increase tension on the strap brace once the strap brace is secured to the frame. Tensioners work by reducing the effective length of the strap brace, wherein the effective length is defined as the length of the strap brace measured along a straight line without regard to any loops and kinks along the actual length of the strap brace.

Typically, tensioners comprise a curved cap to accommodate a length of strap brace, and a fastener to secure the strap brace onto the cap. In use, a length of strap brace is secured by its ends to a frame and the strap brace is tensioned by fastening the tensioner onto the strap brace. This forces the strap brace onto the curved surface of the tensioner, thereby reducing the effective length of the strap brace.

A problem associated with these tensioners is that positioning of the lining or insulation on the frame may affect the accessibility of the tensioner. Additionally, the fastening process is confined to either manual driving or power driving of the tensioner onto the strap brace. A disadvantage of tool-dependent tensioners is that a user is required to have equipment at hand to effect the tensioning.

It may be advantageous to provide a tensioner for tensioning strap braces that is not limited to a single face for fastening onto a strap brace. More advantageously, the tensioner can be fastened using both manual driving and power driving methods.

### SUMMARY OF THE INVENTION

The present invention provides a device for tensioning strap braces that can use both manual and power driving means.

In accordance with one aspect, there is provided a tensioner for a strap brace comprising:

a cap for receiving a fastener and a strap brace, wherein the fastener secures the strap brace to the cap;

the fastener comprising first and second members with interengageable threads, wherein either can be turned to bring the strap brace under tension; and

a frictioned surface to prevent rotation of the other member when one member is turned.

The frictioned surface can be located on either or both the first and second members and include protrusions such as teeth, ridges, serrations or the like, or textures such as sandpaper quality finishing, non-slip coatings or the like. The frictioned surface can also be separate from the first and second members. For example, the frictioned surface can be located on a washer positioned between the first or second member and the cap.

In an embodiment, the cap is curved to receive a strap brace such that the effective length of the strap brace is reduced when it is fastened against the surface of the cap.

In an embodiment, the frictioned surface is a ratchet surface located on each of the first and second members, wherein teeth on the ratchet surface of the first member are facing in an opposing direction to teeth on the ratchet surface of the second member.

Rotation of the first member in the direction of the teeth causes a corresponding rotation of the second member in the same direction. However, orienting the ratchet surface teeth in opposing directions prevents this rotation by restricting movement of the second member against the direction of the ratchet teeth and aids fastening of the strap brace onto the tensioner.

In an embodiment, the fastener includes a washer with the frictioned surface to prevent rotation of both first and second members when one member is turned.

The washer frictioned surface includes protruding teeth, ridges, non-slip coatings such as rubber or neoprene, sandpaper quality finishing or the like to provide grip to each member on a surface.

When a member does not possess a frictioned surface, the washer provides the frictioned surface to the member and aids fastening of the tensioner onto the strap brace.

Alternatively, when a member has a frictioned surface, the washer can be used to provide a replaceable frictioned surface to minimise wear of the member surface. In this embodiment, the washer possesses a complementary surface profile to the member surface such that one surface of the washer is received by the member and the other surface serves as the frictioned surface.

In an embodiment, the washer includes a series of protruding teeth to provide grip to each member on a surface. Preferably, the washer is a tooth lock washer including internal or external teeth.

In an embodiment, the first member is turned by manual driving.

The first member is turned by manual driving including finger turning, using a claw hammer or the like, and may also be turned by power driving using a power tool such as an electric drill with an appropriate bit.

In an embodiment, the second member is turned by power driving.

The second member is turned by power driving using a power tool such as an electric drill with an appropriate bit and may also be turned by hand using a screw driver, manual drill or the like.

In an embodiment, the cap is curved to comprise a convex face and a concave face such that the strap brace is received within the concave face of the cap, and the first member is located on the convex face of the cap.

The first member is located on the convex face of the cap to improve accessibility of the first member to manual driving, particularly finger turning. If the first member is located on the concave face of the cap, the arms of the curvature make it difficult to access the first member for turning.

In an embodiment, the first member is a nut which is turned by manual driving, and the second member is a bolt which is turned by manual and/or power driving. Preferably, the nut is a wing nut, wherein the wings improves finger grip on the nut for ease of turning. More preferably, the bolt head includes a Phillips screw head, a slot screw head, a hex socket screw head, a combination flanged-hex/Phillips screw head or the like to allow manual driving of the bolt.

### BRIEF DESCRIPTION OF DRAWINGS

A preferred embodiment of the present invention is hereinafter described by way of example only, with reference to the accompanying drawings, wherein:

FIGS. 1A and 1B are in-situ side views of the tensioner in a first working orientation.

FIG. 2 is an in-situ side view of the tensioner in a second working orientation.

FIG. 3 is an in-situ side view of the tensioner in a second working orientation including a washer.

FIG. 4 is a perspective view of a combination flanged-hex/Phillips screw head bolt of a fastener.

FIG. 5 is a side view of a pan head Phillips screw head bolt of a fastener.

FIG. 6 is a bottom view of the ratchet teeth profile of the bolt head illustrated in FIGS. 4 and 5, and the ratchet teeth profile of the nut illustrated in FIGS. 9A and 9B, respectively.

FIG. 7 is a bottom view of an alternative serrated teeth profile that can be used on the bolt head illustrated in FIGS. 4 and 5 and the nut illustrated in FIGS. 9A and 9B, respectively.

FIG. 8 is a perspective view of a cap of a tensioner.

FIGS. 9A and 9B are top and bottom perspective views of a wing nut of a fastener.

FIGS. 10A and 10B are top and perspective views of a tooth lock washer with internal teeth.

FIGS. 11A and 11B are top and perspective views of a tooth lock washer with external teeth.

### DETAILED DESCRIPTION OF AN EMBODIMENT

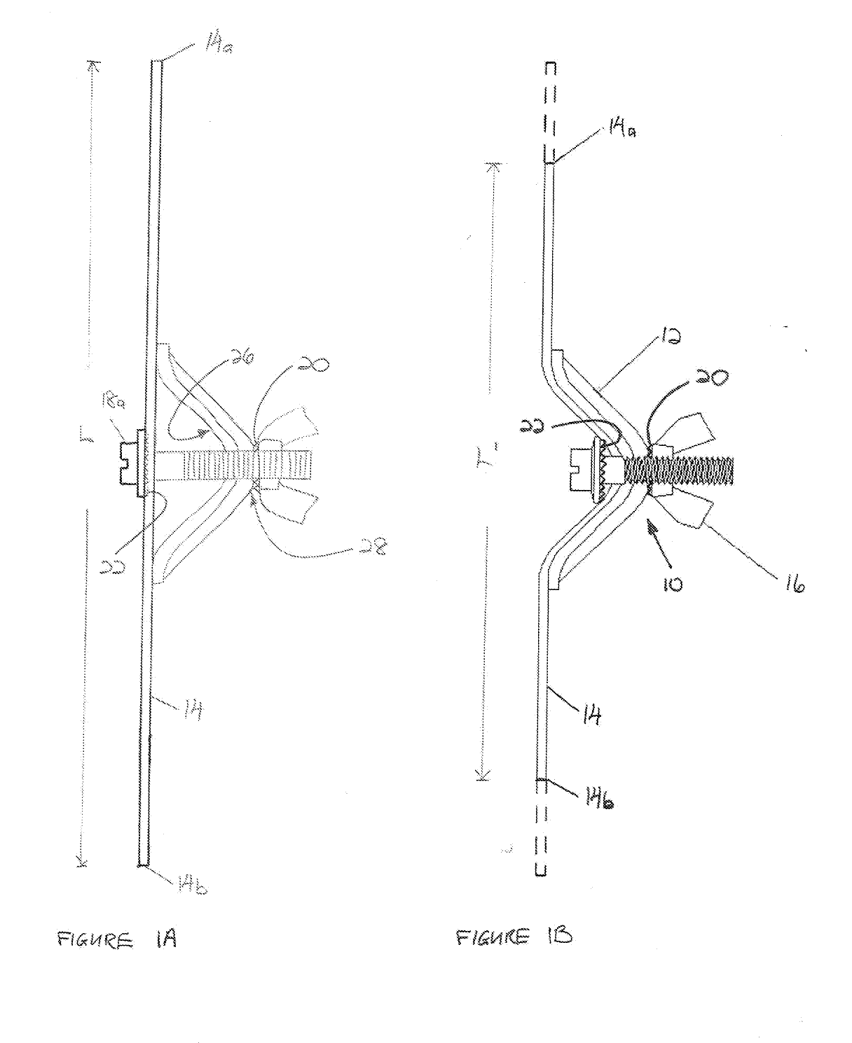

One form of a tensioner generally denoted as 10 is illustrated in FIGS. 1A, 1B and 2 of the accompanying drawings.

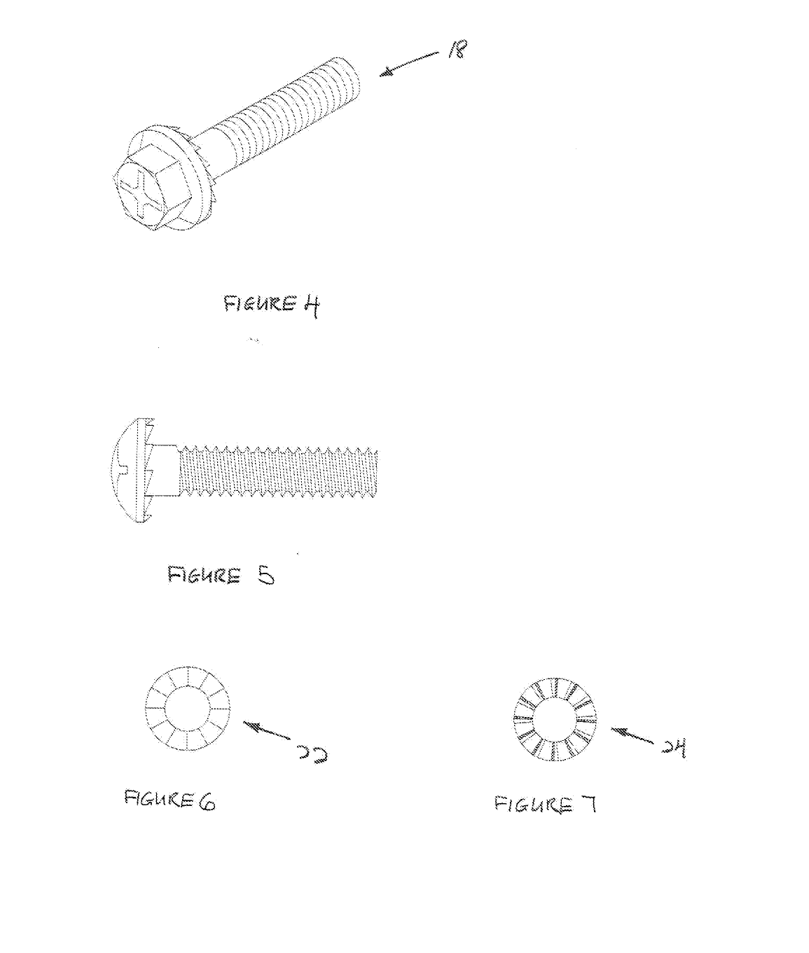

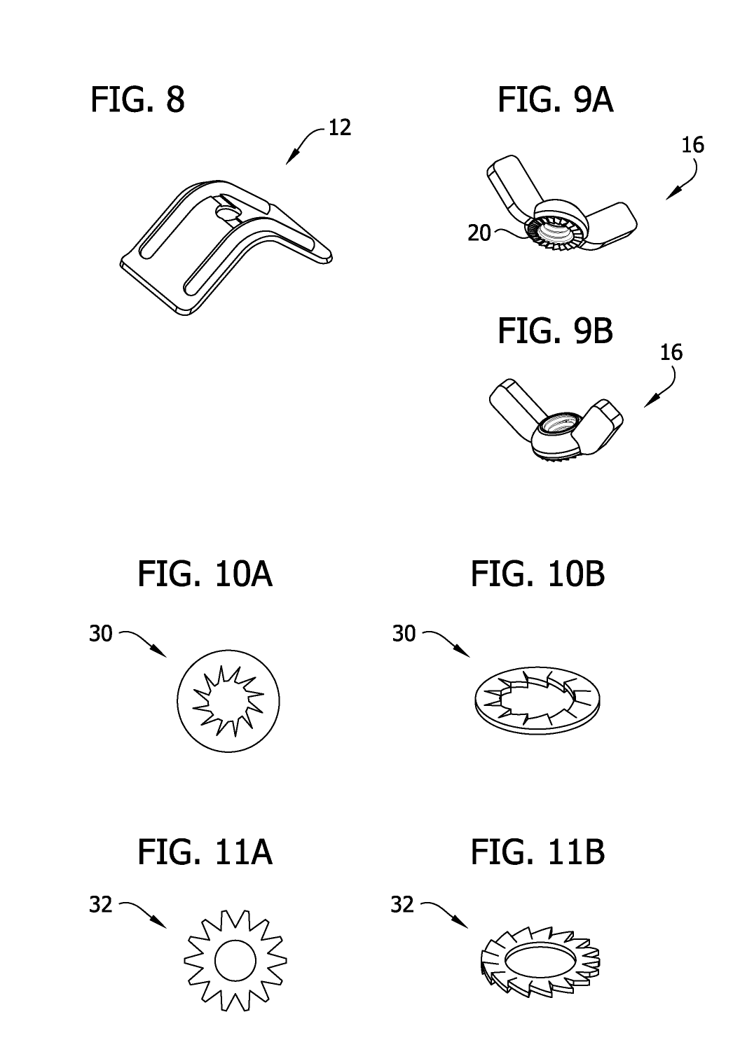

Tensioner 10 comprises cap 12 (FIG. 8) for receiving a fastener and strap brace 14. The fastener comprises a first member in the form of wing nut 16 and a second member in the form of combination flanged-hex/Phillips screw head bolt 18 (FIG. 4). The second member may also be in the form of a pan head Phillips screw head bolt (FIG. 5)

Each of wing nut 16 (FIGS. 9A and 9B) and bolt 18 (FIGS. 4 and 5) include a frictioned surface in the form of ratchet surfaces 20 and 22 (FIG. 6), respectively, to prevent rotation of both wing nut 16 and bolt 18 when either wing nut or bolt is turned.

Alternatively, frictioned surfaces in the form of serrated teeth profiled surface 24 as illustrated in FIG. 7 can be used to prevent rotation of both wing nut 16 and bolt 18.

Ends 14a and 14b of strap brace 14 are secured to a support frame and tensioner 10 is affixed onto the strap brace. In a first working orientation as illustrated in FIG. 1A, wing nut 16 is located immediate to cap 12 while bolt 18 is located immediate to strap brace 14. The wing nut is located on convex portion 28 of cap 12 while bolt head 18a is located towards concave portion 26. Bolt head 18a directly opposes wing nut 16.

This arrangement provides improved accessibility to wing nut 16 for manual turning because the wings of the nut are not hindered by the arms of cap 12, making wing nut 16 easier to turn.

In order to tension strap brace 14, either wing nut 16 or bolt 18 can be turned. This forces strap brace 14 onto concave portion 26 of cap 12 as illustrated in FIG. 1B. This reduces effective length L of strap brace 14 to impart a compressive force onto the frame. The reduction in effective length L to reduced length L′ is illustrated by the broken lines in FIG. 1B.

Wing nut 16 is manually driven by finger turning while bolt 18 can be either manually driven using a screw driver or power driven using an electric drill with an appropriate bit.

When either wing nut 16 or bolt 18 is turned, the rotational force on either member elicits a similar rotation to the other member. In order to prevent this rotation, ratchet surface 20 located on the underside of wing nut 16 grips cap 12 to prevent rotation of wing nut 16 against the direction of the teeth when bolt 18 is turned. Similarly, ratchet surface 22 located on the underside of bolt 18 grips strap brace 14 to prevent rotation of bolt 18 against the direction of the teeth when wing nut 16 is turned.

In a second working orientation illustrated in FIG. 2, wing nut 16 can be located on concave portion 26. This arrangement may be selected if the orientation of the wing nut on convex portion 28 is not possible due to the positioning of lining or insulation on the frame. This arrangement may also be selected if power driving using power tools such as an electric drill is used to fasten the tensioner onto the strap brace—by locating bolt head 18a on convex portion 28, improved accessibility of the electric drill to the bolt head makes the fastening process easier.

In another embodiment, either ratchet surface 20 or 22 is present. In such an embodiment, rotation of a member is limited by the location of the ratchet surface.

For example, if only ratchet surface 20 is present, the tensioner operates by turning bolt 18, whereby ratchet surface 20 provides grip to prevent rotation of wing nut 16 when bolt 18 is turned. Alternatively, if ratchet surface 22 is present, the tensioner operates by turning wing nut 16, whereby ratchet surface 22 provides grip to prevent rotation of bolt 18 when wing nut 16 is turned. This is applicable for both first and second working orientations.

In a first working orientation, wherein wing nut 16 does not possess a frictioned surface 20, washer 30 as illustrated in FIGS. 10A and 10B can be inserted between wing nut 16 and cap 12. Internal teeth on washer 30 project from the top and bottom surfaces of the washer and provide a gripping surface between wing nut 16 and cap 12 (FIG. 1B).

Alternatively, in a second working orientation, wherein wing nut 16 does not possess a frictioned surface 20, washer 30 can be inserted between wing nut 16 and strap brace 14 to provide a gripping surface.

Similarly, in a first working orientation, if bolt head 18a does not possess a frictioned surface 22, washer 30 can be inserted between bolt head 18a and strap brace 14 to provide a gripping surface.

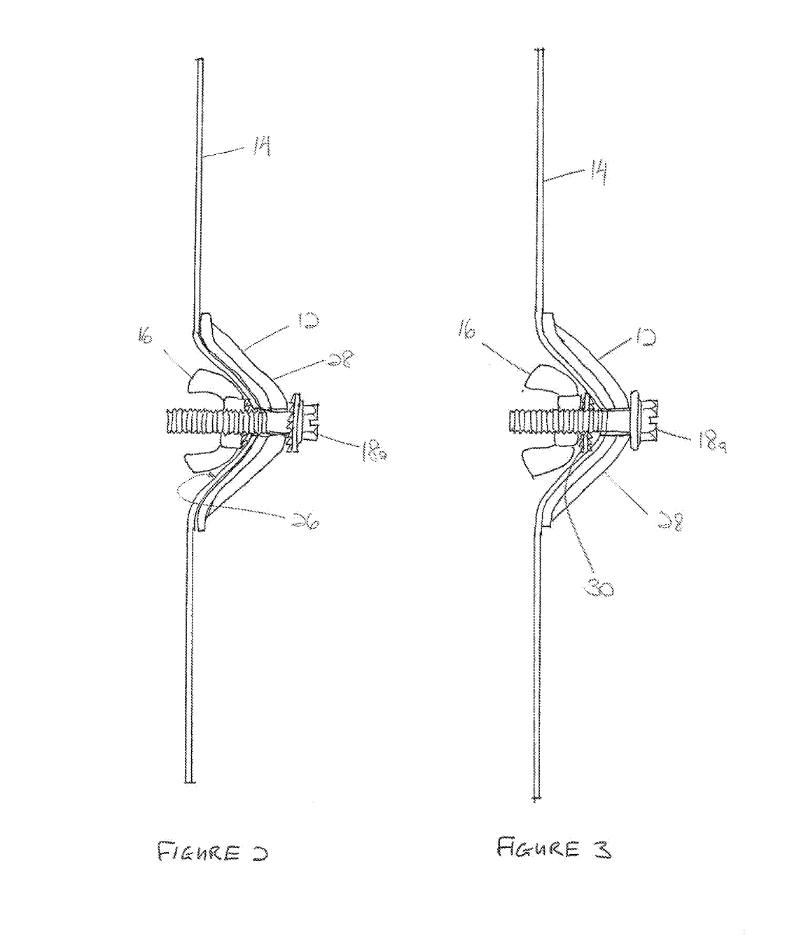

Alternatively, in a second working orientation, wherein bolt head 18a does not possess a frictioned surface 22, washer 30 can be inserted between bolt head 18a and cap 12, or washer 30 can be inserted between wing nut 16 and strap brace 14 (FIG. 3) to provide a gripping surface.

Alternatively, washer 32 including external teeth as illustrated in FIGS. 11A and 11B can be inserted in place of washer 30 to provide a gripping surface.

Washers with complementary surfaces to ratchet surfaces 20 and 22 can be used to provide a replacement frictioned surface to prolong the life of the fastener. In this embodiment, the complementary surface is received by surfaces 20 and 22 while the opposed surface of the washer provides the frictioned surface to prevent rotation of both members when one member is turned.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The claims defining the invention are as follows:

1. A tensioner for a strap brace comprising:
a cap for receiving a fastener and a strap brace, wherein the fastener secures the strap brace to the cap;
the fastener comprising first and second members with interengageable threads, wherein either can be turned to bring the strap brace under tension; and
a frictioned surface to prevent rotation of the other member when one member is turned.

2. A tensioner according to claim 1, wherein the frictioned surface is a ratchet surface located on each of the first and second members, wherein teeth on the ratchet surface of the first member are facing in an opposing direction to teeth on the ratchet surface of the second member.

3. A tensioner according to claim 2, wherein the first member is structured for turning by manual driving.

4. A tensioner according to claim 2, wherein the second member is structured for turning by power driving.

5. A tensioner according to claim 2, wherein the first member is a nut which is structured for turning by manual driving, and the second member is a bolt which is structured for turning by manual and/or power driving.

6. A tensioner according to claim 2, wherein the cap is curved to comprise a convex face and a concave face such that the strap brace is received within the concave face of the cap, and the first member is located on the convex face of the cap.

7. A tensioner according to claim 2, wherein the cap is curved to comprise a convex face and a concave face such that the strap brace is located between the first member and the cap within the concave face of the cap, and the second member is located on the convex face of the cap.

8. A tensioner according to claim 1, wherein the fastener includes a washer with the frictioned surface to prevent rotation of both first and second members when one member is turned.

9. A tensioner according to claim 8, wherein the washer includes a series of protruding teeth to provide grip to each member on a surface, or a coating such as rubber or neoprene.

10. A tensioner according to claim 8, wherein the first member is structured for turning by manual driving.

11. A tensioner according to claim 8, wherein the second member is structured for turning by power driving.

12. A tensioner according to claim 8, wherein the first member is a nut which is structured for turning by manual driving, and the second member is a bolt which is structured for turning by manual and/or power driving.

13. A tensioner according to claim 8, wherein the cap is curved to comprise a convex face and a concave face such that the strap brace is received within the concave face of the cap, and the first member is located on the convex face of the cap.

14. A tensioner according to claim 8, wherein the cap is curved to comprise a convex face and a concave face such that the strap brace is located between the first member and the cap within the concave face of the cap, and the second member is located on the convex face of the cap.

15. A tensioner according to claim 1, wherein the first member is structured for turning by manual driving.

16. A tensioner according to claim 15, wherein the second member is structured for turning by power driving.

17. A tensioner according to claim 1, wherein the second member is structured for turning by power driving.

18. A tensioner according to claim 1, wherein the cap is curved to comprise a convex face and a concave face such that the strap brace is received within the concave face of the cap, and the first member is located on the convex face of the cap.

19. A tensioner according to claim 1, wherein the cap is curved to comprise a convex face and a concave face such that the strap brace is located between the first member and the cap within the concave face of the cap, and the second member is located on the convex face of the cap.

20. A tensioner according to claim 1, wherein the first member is a nut which is structured for turning by manual driving, and the second member is a bolt which is structured for turning by manual and/or power driving.
